(19) United States
(12) Patent Application Publication
(10) Pub. No.: US 2008/0303268 A1
(43) Pub. Date: Dec. 11, 2008

(54) Fluid transport system

(75) Inventor: Benny D. Puck, Manning, IA (US)

Correspondence Address: BRETT J. TROUT, PC, 516 WALNUT, DES MOINES, IA, 50309, US

(73) Assignee: Puck Custom Enterprises, Inc.

(21) Appl. No.: 11/810,846

(22) Filed: Jun. 7, 2007

(51) Int. Cl. B60D 1/64

(52) U.S. Cl. 285/62; 285/115; 285/223

(57) ABSTRACT

A fluid delivery system for a fluid distribution system such as a manure distribution inlet. The invention provides an improved coupling between a supply hose and the newer distribution implement includes an angled pipe coupled to a first collar and a second collar. The collars define keyways within which rotate an annular key provided around an inlet pipe and an annular key provided around an outlet pipe. The inlet pipe, outlet pipe and angled pipe are preferably constructed of polished steel to reduce the wear associated with constant rotation of the pipes relative to one another. The combination of the keyways and polished steel construction allows the pipe to be rotated constantly with only a minimum amount of wear, and improved maintenance and failure characteristics.

### BACKGROUND OF THE INVENTION

1. Field of the Invention

The present invention relates in general to a fluid delivery system and, more particularly, to a journaled pipe for use in association with a boom and hose for the agricultural delivery of fluid.

2. Description of the Prior Art

It is known in the prior art to provide fluids, such as liquid manure, in large hoses for use as fertilizer. Long hoses constructed of flexible plastic are used to deliver the liquid manure to a machine which distributes the liquid manure into the soil. The pump used to pump the manure stays generally stationary, while the manure distribution implement moves back and forth across the agricultural field. As the implement moves back and forth, the hose tends to bind as the implement moves at sharp angles relative to the pump. Accordingly, pipe fitments are provided on the manure distribution implement. The pipe fitments rotate to prevent the hose from encountering sharp angles and to prevent the hose from kinking, twisting or otherwise restricting the flow of fluid through the hose.

Such prior art systems are generally constructed of metal pipes journaled to one another using a system of bearings and/or gaskets. One drawback associated with such prior art systems is that the movement of metal on metal wears quickly, resulting in high maintenance costs and/or high failure rates. Another drawback is the weight and cost associated with such systems.

It would, therefore, be desirable to provide a system for further reducing torsion and kinking of a hose relative to a manure distribution implement. It would also be desirable to provide a system for connecting a hose to a manure distribution implement which was of a low-cost, lightweight manufacture. It would additionally be desirable to provide a system for coupling a hose to a manure distribution system which reduced the metal-on-metal wear associated with prior art systems. The difficulties encountered in the prior art discussed hereinabove are substantially eliminated by the present invention.

### SUMMARY OF THE INVENTION

In an advantage provided by this invention, a fluid delivery system is provided which is of a lightweight, low cost manufacture.

Advantageously, this invention provides a fluid delivery system with improved wear characteristics.

Advantageously, this invention provides a fluid delivery system which reduces undesirable failure associated with frictional torsion between parts.

Advantageously, this invention provides a fluid delivery system with improved maintenance characteristics.

Advantageously, this invention provides a fluid delivery system which reduces kinks and torsion associated with hoses supplying manure distribution implements with liquid manure.

Advantageously, in a preferred embodiment of this invention, a fluid delivery system is provided. The fluid delivery system includes an angled pipe coupled to an inlet pipe and an outlet pipe. A first collar retains the inlet pipe to the angled pipe and a second collar retains the outlet pipe to the angled pipe. In the preferred embodiment, the inlet pipe, outlet pipe and angled pipe are all constructed of steel. The collars are constructed of metal and define keyways within which annular keys provided on the inlet pipe and outlet pipe rotate. The collars are secured to the angled pipe, thereby allowing the inlet pipe, outlet pipe and angled pipe all to move relative to one another.

### BRIEF DESCRIPTION OF THE DRAWINGS

The present invention will now be described, by way of example, with reference to the accompanying drawings in which:

FIG. 1 illustrates a rear perspective view of the fluid delivery system of the present invention provided on a manure spreader;

FIG. 2 illustrates a side perspective view of the fluid delivery system of FIG. 1;

FIG. 3 illustrates a top perspective view of an impeller of the present invention;

FIG. 4 illustrates a side perspective view in partial cross-section of the journaled fluid delivery system of the present invention;

FIG. 5 illustrates a side perspective view in cross-section of the journaled fluid delivery system of the present invention; and

FIG. 6 illustrates a front perspective view of a fluid pump and container of the present invention.

### DETAILED DESCRIPTION OF THE PREFERRED EMBODIMENTS

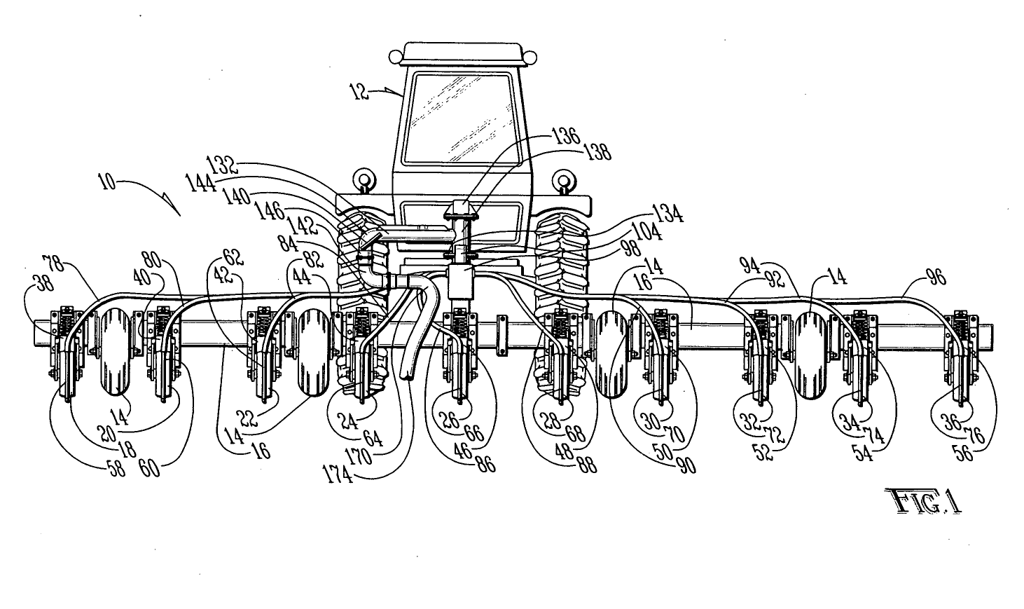

A manure delivery implement according to the present invention is shown generally as (10) in FIG. 1. The implement (10) is coupled to a tractor (12) or similar vehicle to pull the implement (10). Provided on the implement (10) are wheels (14) coupled to a frame (16). Depending from the frame (16) are coulters (18), (20), (22), (24), (26), (28), (30), (32), (34) and (36). Also depending from the frame are knife assemblies (38), (40), (42), (44), (46), (48), (50), (52), (54) and (56). Coupled to each knife assembly (38-56) is a nozzle (58), (60), (62), (64), (66), (68), (70), (72), (74) and (76), and coupled to each nozzle (58-76) is a hose (78), (80), (82), (84), (86), (88), (90), (92), (94) and (96). The hoses (78-96) are coupled to a manifold (98) secured to the frame (16).

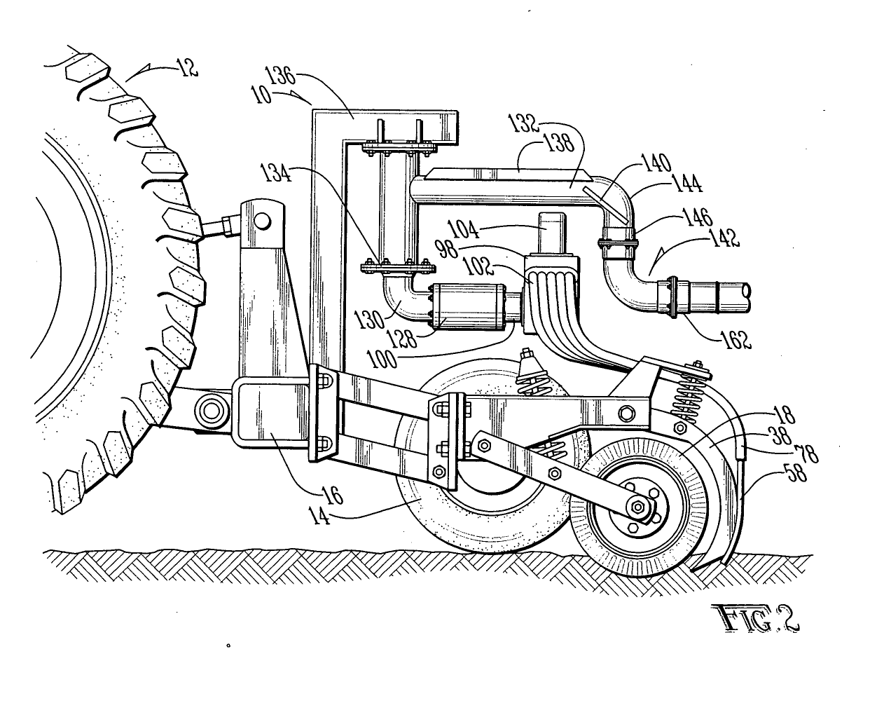

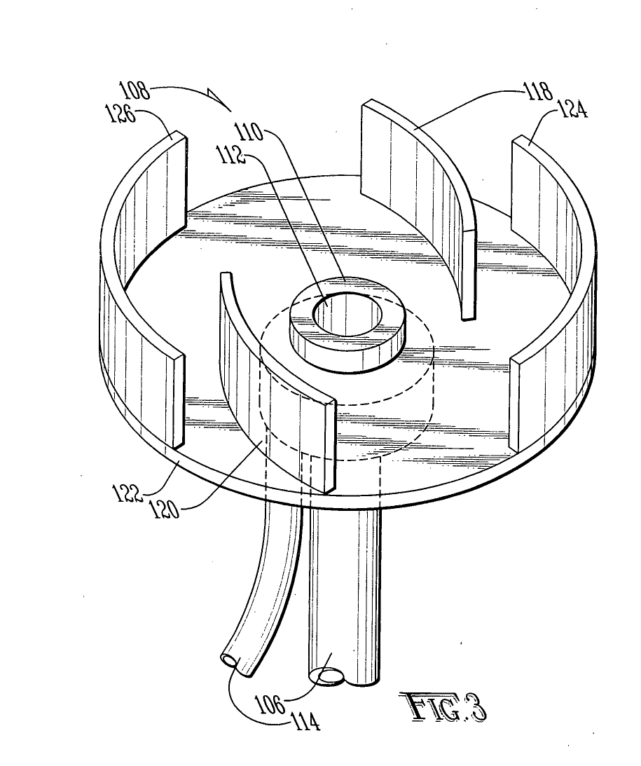

The manifold (98) is provided with a fluid input (100) and a plurality of fluid outputs (102). (FIGS. 1-2). Provided on top of the manifold (98) is a hydraulic motor (104), driven by hydraulics associated with the tractor (12). The motor (104) is coupled to a shaft (106) which, in turn, is secured to an impeller (108). (FIGS. 2-3). As shown in FIG. 3, the impeller (108) is welded to an annular boss (110) which defines a fluid input opening (112). An input hose (114) is provided in fluid communication with the fluid input opening (112). The impeller (110) is a steel plate (116). Welded to the plate (116) are arcuate impeller blades (118) and (120), which extend radially from the boss (110) toward the circumference (122) of the impeller (108).

Provided along the circumference (122) are a pair of shut-off gates (124) and (126). Preferably, the impeller blades (118) and (120), and shut-off gates (124) and (126), are constructed of steel. While the configuration, orientation and dimensions of the impeller blades (118) and (120), and shut-off gates (124) and (126) may be of any desired dimension suitable for the flow rate and consistency of the material being applied, in the preferred embodiment, the shut-off gates (124) and (126) are each sized to cut off more than one, but less than two, of the outputs (102) coupled to the manifold (98). If desired, the shut-off gates (124) and (126) can be sized to shut off anywhere from a portion of one gate to all but a portion of one gate.

Similarly, the impeller blades (118) and (120) may be constructed of any suitable length and may be provided in any suitable number. While in the preferred embodiment the impeller blades (118) and (120) are positioned symmetrically, if desired, a plurality of impeller blades (118) may be positioned all across the plate (116) to move material as desired.

The input (100) of the manifold (98) is coupled to a fluid pump (128) driven by hydraulics associated with the tractor (12). The pump (128) is coupled to an angled pipe (130) which, in turn, is coupled to a boom (132) by a gasket assembly (134) which allows the boom (132) to swivel relative to the pipe (130). The boom (132) is journaled to a boom frame (136) which allows the boom (132) to pivot relative to the manure delivery implement (10). Provided along the top of the boom (132) is a strengthening rib (138).

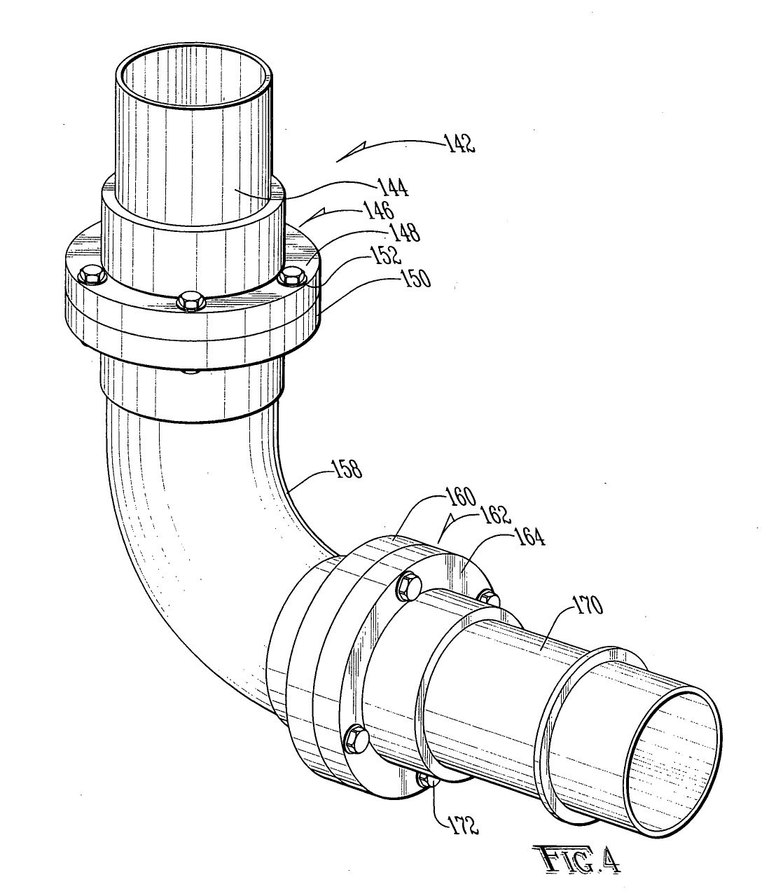

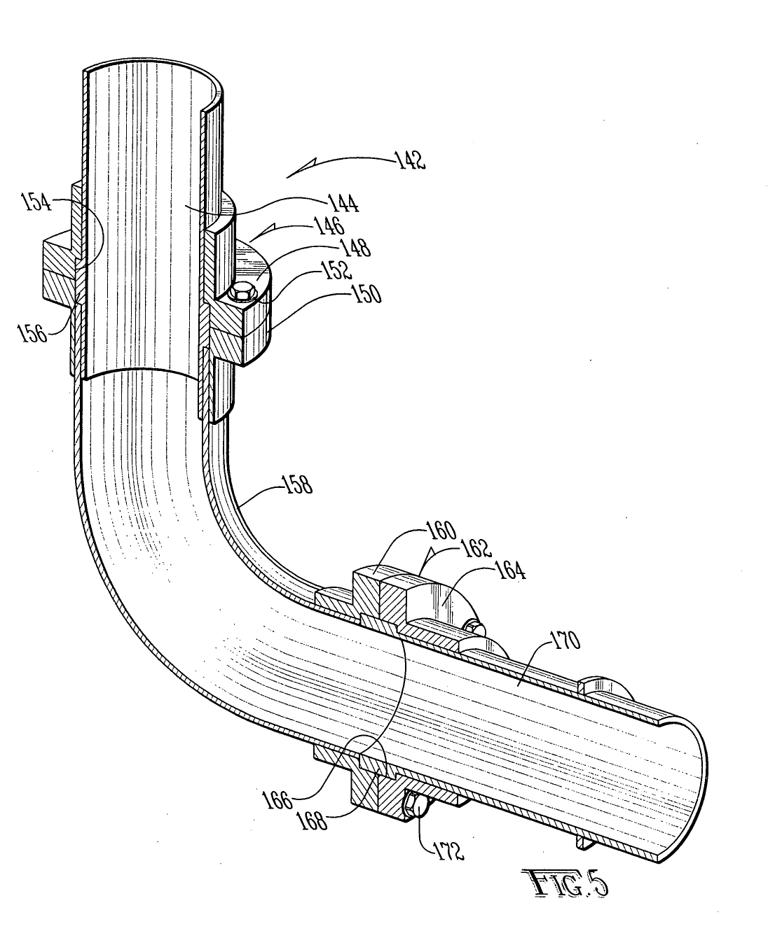

A curved outlet pipe (144) is coupled to the end of the boom (132) and secured thereto by brace bars (140). The outlet pipe (144) forms a portion of a swivel fluid transport system (142) which also includes a collar (146) provided around the outlet pipe (144). As shown in FIGS. 4-5, the collar (146) includes a first half (148) and a second half (150), secured to one another by bolts (152). The first half (148) and second half (150) of the collar (146) define a keyway (154) provided around a raised annular key (156) surrounding a portion of the outlet pipe (144). Secured to the second half (150) of the collar (146) is an angled pipe (158) which, in turn, is coupled to the first half (160) of a second collar (162). The first half (160) of the second collar (162), along with a second half (164), define a keyway (166) provided around an annular key (168) of an inlet pipe (170).

The first half (160) and second half (164) of the second collar (162) are secured to one another by bolts (172). While the outlet pipe (144), angled pipe (158) and inlet pipe (170) may be constructed of any suitable materials, in the preferred embodiment they are constructed of steel pipe to reduce the abrasion associated with prior art swivel systems. Alternatively, the pipes (144), (158) and (170) may be constructed of any combination of metal and non-metal components so that metal to metal contact of the pipes (144), (158) and (170) are eliminated.

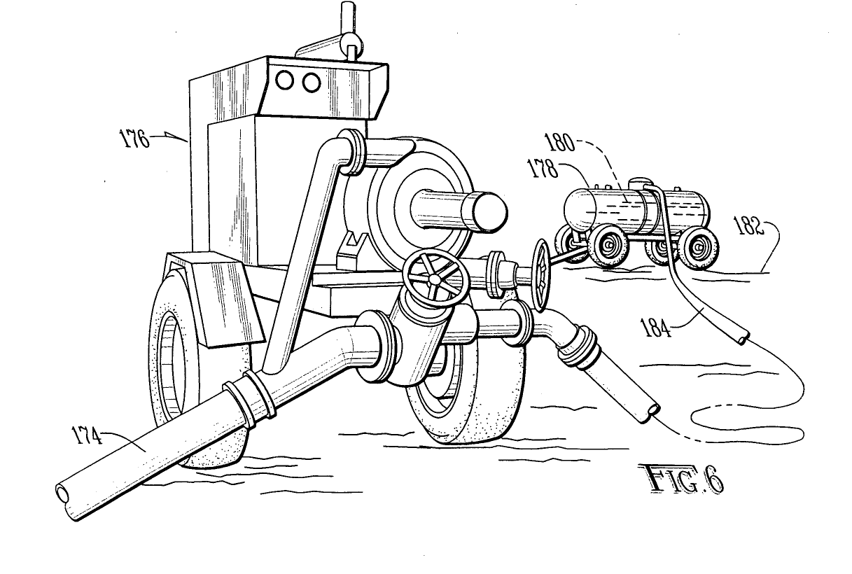

As shown in FIG. 1, coupled to the end of the inlet pipe (170) is a hose (174) such as that known in the prior art for the delivery of liquid manure and the like. As shown in FIG. 6, the other end of the hose (174) is coupled to a fluid pump (176) such as that known in the art. The fluid pump (176), in turn, is coupled to a fluid container (178) such as that known in the art for containing liquid manure and the like.

When it is desired to utilize the implement (10) of the present invention, a fluid container (178) filled with liquid manure (180), such as those known in the art, is positioned on or near the field (182) on to which it is desired to apply the liquid manure (180). Thereafter, the container (178) is coupled to the fluid pump (176) by a connector hose (184). The fluid hose (174) is then positioned on the field (182) using a hose reel or similar device known in the art. The hose (174) is coupled to the pump (176) on one end, and coupled to the inlet pipe (170) on the other end. The pump (176) is then actuated to pump the liquid manure (180) through the hose (174) to the implement (10).

The operator then drives the tractor (12) back and forth across the field (182), pulling the implement (10) there behind. As the implement (10) is drawn across the field (182), the liquid manure (180) moves through the swivel fluid transport system (142). The drag of the hose (174) across the field (182) pulls the inlet pipe (170) of the swivel fluid transport system (142) toward the portion of the hose (174) in contact with the field (182). Accordingly, as the tractor (12) traverses back and forth across the field (182), the swivel fluid transport system (142) swivels back and forth to prevent the hose (174) from being kinked, damaged or bent as the tractor (12) moves back and forth. Similarly, as the tractor (12) pulls the implement (10) back and forth across the field, the boom (132) pivots back and forth on the boom frame (136) to position the swivel fluid transport system (142) toward the portion of the hose (174) in contact with the field (182). The pivoting of the boom (132) additionally reduces kinking and binding on the hose (174) and positions the hose away from the implement (10) to prevent the tractor (12) or implement (10) from running over the hose (174) during use. The liquid manure (180) moves through the hose (174), fluid transport system (142), boom (132) and angled pipe (130). The liquid manure (180) thereafter moves into contact with the pump (128) which pushes the liquid manure (180) into the manifold (98) and into contact with the impeller (108).

The hydraulic motor (104) drives the impeller blades (118) and (120) into contact with the liquid manure (180), forcing the liquid manure outward toward the circumference (122) of the impeller (108). The shut-off gates (124) and (126) are preferably sized to shut off access to at least two of the hoses (78), (80), (82), (84), (86), (88), (90), (92), (94) and (96) at a time. Accordingly, at any one time, the impeller (108) is only feeding six of the hoses (78-96). Although the openings to more than six gates may be partially open at any one time, the overall equivalent of liquid manure (180) flowing out of the impeller (108) is roughly equivalent to the flow to six hoses (78-96). As the impeller blades (118) and (120) generate pressure of the liquid manure (180) out of the manifold (98), and as the shut off gates (124) and (126) restrict the flow of liquid manure (180) to various hoses (78-96), the flow of liquid manure (180) through the remaining hoses is significantly increased in pressure. Accordingly, the liquid manure (180) flowing out of a hose at any given time is substantially greater than the flow would be without the use of the impeller (108). Preferably, the flow to the hoses (78) and (96), located on the far ends of the implement (10), realizes significantly improved liquid manure (180) flow characteristics and pressure to more evenly apply the liquid manure (180). The liquid manure (180) moves through the hoses (78-96) and through the nozzles (58-76) into furrows (184) created by the coulters (18-36) and knife assemblies (38-56).

The foregoing description and drawings merely explain and illustrate the invention, and the invention is not limited thereto, except insofar as the claims are so limited, as those skilled in the art who have the disclosure before them will be able to make modifications and variations therein without departing from the scope of the invention. For example, the implement (10) may be provided with any desired number of hoses and the implement (10) may be utilized in association with any desired material, including, but not limited to, herbicides, pesticides, fertilizer or minerals.

What is claimed is:

1. A fluid transport system comprising:
(a) an inlet pipe;
(b) an outlet pipe;
(c) an angled pipe;
(d) a first collar retaining said inlet pipe to said angled pipe;
(e) a second collar retaining said outlet pipe to said angled pipe;
(f) means for allowing said angled pipe and said inlet pipe to rotate at least ninety degrees relative to one another; and
(g) means for allowing said angled pipe and said outlet pipe to rotate at least ninety degrees relative to one another.

2. The fluid transport system of claim 1, wherein said angled pipe is secured against movement relative to said first collar and said second collar.

3. The fluid transport system of claim 2, wherein said first collar and said second collar are constructed of metal and wherein said angled pipe is constructed of non-metallic material.

4. The fluid transport system of claim 1., wherein said first collar is provided with a keyway.

5. The fluid transport system of claim 4, further comprising a key provided on said inlet pipe.

6. The fluid transport system of claim 4, wherein said keyway extends concentrically around an interior surface of said first collar.

7. The fluid transport system of claim 6, further comprising a key provided concentrically around an exterior of said inlet pipe.

8. The fluid transport system of claim 5, wherein said first collar comprises:
(a) a first sleeve extending upstream of said key;
(b) a second sleeve extending downstream of said key; and
(c) means for securing said first sleeve to said second sleeve.

9. The fluid transport system of claim 8, wherein said first sleeve is secured around said inlet pipe and wherein said second sleeve is secured around said angled pipe.

10. The fluid transport system of claim 1, further comprising means coupled to said inlet pipe for pumping manure through said inlet pipe.

11. The fluid transport system of claim 11, further comprising a vehicle coupled to said outlet pipe.

12. The fluid transport system of claim 1, further comprising a flexible hose coupled to said inlet pipe.

13. A fluid transport system comprising:
(a) a fluid pump;
(b) a fluid container coupled to said pump;
(c) a hose in fluid communication with said pump;
(d) a rigid inlet pipe coupled to said hose; and
(e) a rigid angled pipe concentrically and rotatably coupled to said inlet pipe.

14. The fluid transport system of claim 13, further comprising a rigid outlet pipe pivotably coupled to said angled pipe.

15. The fluid transport system of claim 14, further comprising a first collar retaining said inlet pipe to said angled pipe and a second collar retaining said outlet pipe to said angled pipe.

16. The fluid transport system of claim 15, wherein said first collar is provided with a keyway.

17. The fluid transport system of claim 16, further comprising a key provided on said inlet pipe.

18. A fluid delivery vehicle comprising:
(a) a carriage;
(b) means provided on said carriage for adding a fluid to soil;
(c) a rigid outlet in fluid communication with said adding means;
(d) a rigid angled pipe pivotably coupled to said outlet pipe;
(e) a rigid inlet pipe coaxially and rotatably coupled to said angled pipe;
(f) a hose coupled to said rigid inlet pipe; and
(g) a pump in fluid communication with said hose.

19. The fluid delivery vehicle of claim 18, further comprising a first collar retaining said inlet pipe to said angled pipe and a second collar retaining said outlet pipe to said angled pipe.

20. The fluid delivery vehicle of claim 19, wherein said first collar is provided with a keyway and further comprising a key provided on said inlet pipe.
